(19) United States
(12) Patent Application Publication
(10) Pub. No.: US 2026/0129630 A1
(43) Pub. Date: May 7, 2026

(54) BEAM INDICATION TO CONFIGURE NETWORK-CONTROLLED REPEATER FOR ACCESS LINK

(71) Applicant: Lenovo (Singapore) Pte. Ltd., Singapore (SG)

(72) Inventors: ALI RAMADAN ALI, Kraiburg am Inn (DE); Karthikeyan Ganesan, Nauheim (DE); Majid Ghanbarinejad, Chicago, IL (US)

(21) Appl. No.: 19/114,429

(22) PCT Filed: Sep. 26, 2023
(86) PCT No.: PCT/IB2023/059553

§ 371 Date: Mar. 21, 2025

Related U.S. Application Data
(60) Provisional application No. 63/377,517, filed on Sep. 28, 2022.

(51) Int. Cl. H04W 72/044; H04W 16/26; H04W 72/232

(52) U.S. Cl. CPC H04W 72/046; H04W 16/26; H04W 72/232

(57) ABSTRACT

Various aspects of the present disclosure relate to a device and methods for a network-controlled (NCR) device to efficiently expand a coverage area of a base station. The repeater device transmits to base station(s) a beam designation of beams of the repeater device capable of communicating with user equipments (UEs) via an third access link. In response, the base station(s) determine(s) that the beam designation identifies two or more UEs in a first beam of the two or more beams that should be serviced using frequency division multiplexing. The base station(s) transmit(s) a configuration to the repeater device for transmission of a downlink and reception of an uplink on the access link between the repeater device and the two or more UEs using the first beam.

### PRIORITY APPLICATION

The application claims priority to U.S. Provisional Application No. 63/377,517, filed Sep. 28, 2022, the content of which is fully incorporated herein.

### TECHNICAL FIELD

The present disclosure relates to wireless communications, and more specifically to network control of a repeater that extends a coverage area for wireless communication.

### BACKGROUND

A wireless communications system may include one or multiple network communication devices, including base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, and other suitable radio access technologies beyond 5G (e.g., sixth generation (6G)).

Coverage is a fundamental aspect of cellular network deployments. Mobile operators rely on different types of network nodes or network devices to offer blanket coverage in their deployments. Deployment of regular full-stack cells is one option but may not be always technically possible or economically viable. As a result, new types of network nodes have been considered to increase mobile operators'flexibility for their network deployments. For example, Integrated Access and Backhaul (IAB) is a new type of network node not requiring a wired backhaul. Another type of network node is a radio frequency (RF) repeater that simply amplifies-and-forwards any signal that the RF repeater receives. RF repeaters have seen a wide range of deployments in 2G, 3G and 4G to supplement the coverage provided by regular full-stack cells. The 5G New Radio (NR) radio access technologies (RATs) have RF and Electromagnetic Compatibility (EMC) requirements for such RF repeaters for NR targeting both Frequency Range 1(FR 1 ) and Frequency Range 2 (FR2).

### SUMMARY

The present disclosure relates to methods, apparatuses, and systems that provide procedures and signaling for a network-controlled repeater (NCR) device to efficiently expand a coverage area of a network device, such as a base station. In one or more embodiments, the present disclosure takes into account the frequency domain multiplexed user equipments (UEs). The present disclosure provides an indication of beam identifiers (IDs) and the associated time resource of the access link of the NCR device. The present disclosure provides an indication of two sets of beam IDs and corresponding time resource for uplink (UL) and for downlink (DL). The present disclosure provides an indication of beam IDs that correspond to wide beams indicated by NCR device capability for forwarding broadcast transmission. The present disclosure provides an indication of beam IDs that correspond to narrow beams within wide beams for beam refinement and dedicated data/reference signaling (RS) transmission. The present disclosure provides an indication of multiple beam IDs per time resource to the NCR device that support simultaneous beam transmission in a slot/symbol.

Some implementations of the method and apparatuses described herein may include a method for wireless communication at a network device, such as a base station. In one or more embodiments, the method includes communicating, via at least one transceiver of a network device, with: (i) a repeater device via a first link; and (ii) a user equipment (UE), indirectly via a second link to the repeater device that repeats communication via a third link with a UE. The method may include receiving, from the repeater device, a beam designation of two or more beams of the repeater device capable of communicating with two or more user devices via the third link. In response to determining that the beam designation identifies two or more UEs in a first beam of the two or more beams, the method may include generating a first configuration of a beam identifier for the first beam and corresponding time domain resources for the two or more UEs using frequency division multiplexing. The method may include transmitting, via the at least one transceiver to the repeater device, one or more control messages including the first configuration. The configuration is transmitted to prompt the repeater device to apply the configuration for transmission of a downlink and reception of an uplink on the third link between the repeater device and the two or more UEs using the first beam.

Some implementations of the method and apparatuses described herein may include a method for wireless communication at a repeater device. In one or more embodiments, the method may include communicating, via at least one transceiver of the repeater device with: (i) at least one network device of a network, such as a base station, via (a) a first link or (b) a second link; and (ii) a UE via a third link. The method may include transmitting, via the at least one transceiver to the at least one network device, a beam designation of two or more beams of the repeater device capable of communicating with two or more UEs via the third link. The at least one base station responds to determining that the beam designation identifies two or more UEs in a first beam of the two or more beams by generating a first configuration of a beam identifier for the first beam and corresponding time domain resources for the two or more UEs using frequency division multiplexing. The method may include receiving, via the at least one transceiver from the at least one network device, one or more control messages comprising the first configuration. The method may include applying the configuration to the at least one transceiver for transmission of a downlink and reception of an uplink on the third link between the repeater device and the two or more UEs using the first beam.

### BRIEF DESCRIPTION OF THE DRAWINGS

FIG. 1 is an example of a wireless communications system enabling repeating of wireless communication by a network-controller repeater (NCR) device, in accordance with aspects of the present disclosure.

FIG. 2 is a portion of the wireless communications system including a network device, the NCR device, and user equipment (UE) that is outside of a coverage area for the network device, in accordance with aspects of the present disclosure;

FIG. 3 is the wireless communications system with the NCR device reporting capability to the network device of supported narrow and wide beams in an access link, in accordance with aspects of the present disclosure.

FIG. 4A is an example code that can be signaled to an NCR-MT using a common configuration, in accordance with aspects of the present disclosure.

FIG. 4B is an example of a dedicated RRC message to the repeater with beam IDs indication and the corresponding time resources, in accordance with aspects of the present disclosure.

FIG. 5 illustrates a block diagram of a device that configures a repeater device with beam indications for repeating of wireless communication to multiple UEs, in accordance with aspects of the present disclosure.

FIG. 6 illustrates a flowchart of a method performed by a network device/base station for configuring a repeater device with beam indications for repeating communication on an access link with multiple UEs, in accordance with aspects of the present disclosure.

FIG. 7 illustrates a flowchart of a method performed by a repeater device to report beam indications for repeating communication on an access link with multiple UEs, in accordance with aspects of the present disclosure.

### DETAILED DESCRIPTION

While a conventional RF repeater presents a cost-effective means of extending network coverage to a communications system, the RF repeater has its limitations. An RF repeater simply does an amplify-and-forward operation without being able to consider various factors that could improve performance. Such factors may include information on semi-static and/or dynamic downlink/uplink configuration, adaptive transmitter/receiver spatial beamforming, ON-OFF status, etc.

A network-controlled repeater (NCR) device is an enhancement over conventional RF repeaters with the capability to receive and process side control information from the network. An NCR device contains two main components/functions, the NCR mobile terminal (NCR-MT) responsible for receiving the side control information via a control link (C-Link) and the NCR forward components (NCR-Fwd) that is responsible for amplifying and forwarding uplink/downlink (UL/DL) physical (PHY) channels/signals for both backhaul and access links. Side control information could allow NCR device to perform the amplify-and-forward operation in a more efficient manner. Potential benefits could include mitigation of unnecessary noise amplification, transmissions and receptions with better spatial directivity, and simplified network integration. The NCR device presents issues with implementing the additional functionality enabled by side control information.

In particular, beam information of the access link, a beam index, and a corresponding time domain resource to apply the beam are indicated to the NCR device instead of using the legacy reference signal resource ID-based beam indication. In the legacy new radio (NR) scheduling procedure, a gNB scheduler can schedule multiple UEs in the same symbol/slot with different RB allocations and tries to schedule user equipments (UEs) that report the same beam quality (i.e., are in the same direction) using frequency division multiplexing (FDM) and UEs with different beams in time division multiplexing (TDM).

Similar, the gNB can communicate with a single beam on the backhaul link due to the fixed location of both. However, the gNB scheduler does not know where each UE is relative to the NCR device on the access link. Thus, the gNB is not enabled to fully allocate the resources, not knowing which UEs are not in the same beam of the access link from the NCR device. Communication efficiencies might be achieved by the gNB to schedule UEs using FDM in the same slot/symbol when the physical beams between the NCR device and the UEs when in different directions. Otherwise, the gNB must rely solely on TDM. The gNB needs an indication of which beams of the NCR device on the access link may serve each UE.

In the present disclosure, a solution for beam indication of the access link is provided, taking into account the frequency domain multiplexed UEs. The present disclosure provides an indication of beam identifiers (IDs) and the associated time resource of the access link of the NCR device. The present disclosure provides an indication of two sets of beam IDs and corresponding time resource for uplink (UL) and for downlink (DL). The present disclosure provides an indication of beam IDs that correspond to wide beams indicated by NCR device capability for forwarding broadcast transmission. The present disclosure provides an indication of beam IDs that correspond to narrow beams within wide beams for beam refinement and dedicated data/reference signaling (RS) transmission. The present disclosure provides an indication of multiple beam IDs per time resource to the NCR device that support simultaneous beam transmission in a slot/symbol.

In one or more aspects of the present disclosure, an NCR device and method performed by the NCR device include receiving, from the gNB, a first configuration for beam IDs and corresponding time resources. The method includes receiving, from the gNB, a second configuration for beam IDs and corresponding time domain resource. The method includes applying the indicated beam IDs on the indicated time domain resources for transmission of DL and reception of UL in an access link between the NCR device and a UE. In one or more embodiments, the first configuration includes indication of beam IDs and time resources that correspond to reported wide beams from the repeater, in the capability report, for forwarding broadcast and the transmission of the initial access channels/signals of the UE(s)

In one or more embodiments, the corresponding time domain resources of the first configuration are specifically indicated along with the beam IDs to the NCR device for each transmission in a repeater dedicated RRC message. In one or more embodiments, the corresponding time domain resources are implicitly indicated based on the Synchronization Signal Block (SSB) /RACH Occasion (RO) configurations in System Information Block 1 (SIB1). In one or more embodiments, the second configuration includes an indication of beam IDs and the time resources that correspond to the reported narrow beams from the NCR device, in the capability report, for forwarding UE dedicated transmission with narrow beams.

In one or more embodiments, the configuration is sent to the NCR device in a repeater dedicated RRC message. In one or more embodiments, the configuration is sent to the repeater in repeater dedicated DCI format. In one or more embodiments, the NCR device receives multiple beam IDs for a slot/symbol to be applied at the repeater simultaneously if the repeater supports simultaneous beam transmission. In one or more embodiments, the gNB transmits the beam indication for the UEs scheduled in frequency domain in a slot/symbol, wherein the beam ID corresponds to a beam reported by the UEs with satisfactory Reference Signal Received Power (RSRP). threshold

In one or more embodiments, the gNB transmits the beam indication for the UEs scheduled in frequency domain in a slot/symbol. The beam ID corresponds to the reported best beam of the UE with high priority data. In one or more embodiments, the priority depends on the QoS of the UEs and whether the forwarded signal is new data or a re-transmission that is given the high QoS and re-transmission higher priority. According to one or more embodiments, the repeater capability and the connected UEs via the repeater are indicated as well as whether the UEs can be served by the same beam or by different beams. These indications are used as an input for UE scheduling at the gNB.

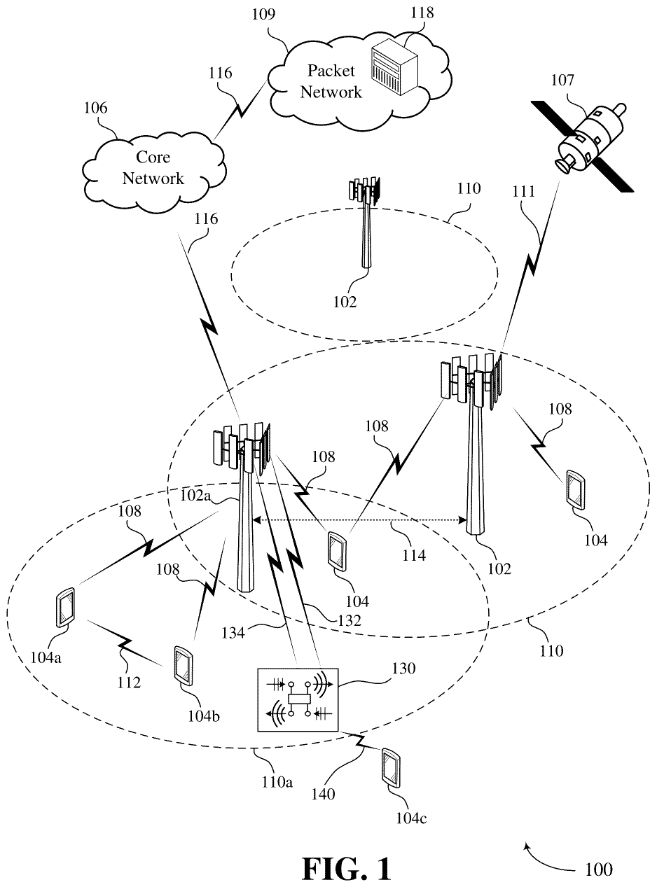

FIG. 1 illustrates an example of a wireless communications system 100 enabling repeating of wireless communication by a network-controller repeater (NCR) device, in accordance with aspects of the present disclosure. The wireless communications system 100 may include one or more network devices 102, one or more UEs 104, a core network 106, and a packet data network 109. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as a New Radio (NR) network. In other implementations, the wireless communications system 100 may be a combination of a 4G network and a 5G network. The wireless communications system 100 may support radio access technologies beyond 5G, or other suitable radio access technology including Institute of Electrical and Electronics Engineers (IEEE) 802.11 (Wi-Fi), IEEE 802.16 (WiMAX), IEEE 802.20. Additionally, the wireless communications system 100 may support technologies, such as time division multiple access (TDMA), frequency division multiple access (FDMA), or code division multiple access (CDMA), etc.

The one or more network devices 102 may be dispersed throughout a geographic region to form the wireless communications system 100. One or more of the network devices 102 described herein may be, may include, or may be referred to as a network node, a base station, a network element, a radio access network (RAN), a base transceiver station, an access point, a NodeB, an eNodeB (eNB), a next-generation NodeB (gNB), a network device, or other suitable terminology. A network device 102 and a UE 104 may communicate via a communication link 108, which may be a wireless or wired connection. For example, a network device 102 and a UE 104 may wirelessly communicate (e.g., receive signaling, transmit signaling) over a user to user (Uu) interface.

A network device 102 may provide a geographic coverage area 110 for which the network device 102 may support services (e.g., voice, video, packet data, messaging, broadcast, etc.) for one or more UEs 104 within the geographic coverage area 110. For example, a network device 102 and a UE 104 may support wireless communication of signals related to services (e.g., voice, video, packet data, messaging, broadcast, etc.) according to one or multiple radio access technologies. In some implementations, a network device 102 may be moveable, for example, a satellite 107 associated with a non-terrestrial network and communicating via a satellite link 111. In some implementations, different geographic coverage areas 110 associated with the same or different radio access technologies may overlap, but the different geographic coverage areas 110 may be associated with different network devices 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network devices 102, other UEs 104, or network equipment (e.g., the core network 106, the packet data network 109, a relay device, an integrated access and backhaul (IAB) node, or another network equipment), as shown in FIG. 1. Additionally, or alternatively, a UE 104 may support communication with other network devices 102 or UEs 104, which may act as relays in the wireless communications system 100.

A UE 104a may also be able to support wireless communication directly with other UEs 104b over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104a may support wireless communication directly with another UE 104b over a PC5 interface. PC5 refers to a reference point where the UE 104a directly communicates with another UE 104b over a direct channel without requiring communication with the network device 102a.

A network device 102 may support communications with the core network 106, or with another network device 102, or both. For example, a network device 102 may interface with the core network 106 through one or more backhaul links 114 (e.g., via an S1, N2, or another network interface). The network devices 102 may communicate with each other over the backhaul links 114 (e.g., via an X2, Xn, or another network interface). In some implementations, the network devices 102 may communicate with each other directly (e.g., between the network devices 102). In some other implementations, the network devices 102 may communicate with each other indirectly (e.g., via the core network 106). In some implementations, one or more network devices 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission and reception points (TRPs).

In some implementations, a network entity or network device 102 may be configured in a disaggregated architecture, which may be configured to utilize a protocol stack physically or logically distributed among two or more network entities or network devices 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity or network device 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission and reception point (TRP). One or more components of the network entities or network devices 102 in a disaggregated RAN architecture may be co-located, or one or more components of the network entities or network devices 102 may be located in distributed locations (e.g., separate physical locations). In some implementations, one or more network entities or network devices 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3(L 3 ), a layer 2 (L2)) functionality and signaling (e.g., Radio Resource Control (RRC), service data adaptation protocol (SDAP), Packet Data Convergence Protocol (PDCP)). The CU may be connected to one or more DUs or RUs, and the one or more DUs or RUs may host lower protocol layers, such as a layer 1(L 1 ) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities or network devices 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more network devices 102 associated with the core network 106.

The core network 106 may communicate with the packet data network 109 over one or more backhaul links 116 (e.g., via an S1, N2, N2, or another network interface). The packet data network 109 may include an application server 118. In some implementations, one or more UEs 104 may communicate with the application server 118. A UE 104 may establish a session (e.g., a protocol data unit (PDU) session, or the like) with the core network 106 via a network entity or network device 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities or network devices 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the network entities or network devices 102 and the UEs 104 may support different resource structures. For example, the network entities or network devices 102 and the UEs 104 may support different frame structures. In some implementations, such as in 4G, the network entities or network devices 102 and the UEs 104 may support a single frame structure. In some other implementations, such as in 5G and among other suitable radio access technologies, the network entities or network devices or network devices 102 and the UEs 104 may support various frame structures (i.e., multiple frame structures). The network entities or network devices 102 and the UEs 104 may support various frame structures based on one or more numerologies.

One or more numerologies may be supported in the wireless communications system 100, and a numerology may include a subcarrier spacing and a cyclic prefix. A first numerology (e.g., p=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities or network devices 102 and the UEs 104 may perform wireless communications over one or more of the operating frequency bands. In some implementations, FR1 may be used by the network entities or network devices 102 and the UEs 104, among other equipment or devices for cellular communications traffic (e.g., control information, data). In some implementations, FR2 may be used by the network entities or network devices 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

Network-controlled repeater (NCR) devices 130 may enable network device 102a to communicate with UE 104c that is outside of coverage area 110a. Network device 102a communicates via control link 132 and backhaul link 134 with NCR device 130. NCR device 130 repeats uplink and downlink signals on backhaul link 134 on access link 140 with UE 104c. NCR device 130 efficiently extends the network coverage in both uplink and downlink with the help of side control information from the network. This information may include time division duplex (TDD) switching, timing information, power control, as well as common and UE dedicated spatial information for beamforming.

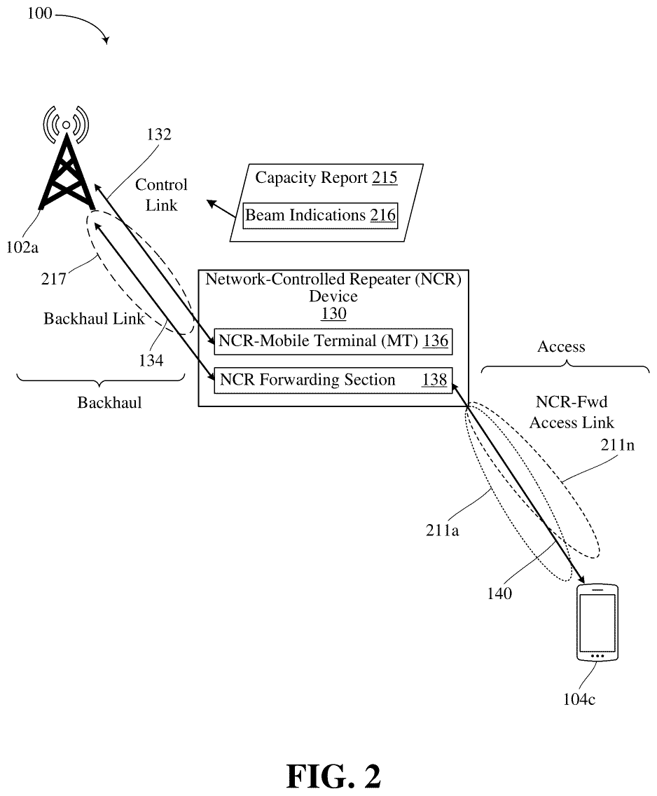

FIG. 2 illustrates a portion of the wireless communications system 100 including the network device 102a, an NCR device 130 and a UE 104c that is outside of a coverage area 110a (FIG. 1) for the network device 102a. Wireless communications system 100 may extend a coverage area 110a for the network device 102a by including an NCR device 130 that is able to reach a UE 104c. NCR device 130 communicates with the network device 102a via both a side control link 132, which may be referred to as a “C-link”, and via a backhaul link 134. The side control link 132 terminates at the NCR device 130 that accordingly acts as an NCR mobile terminal (NCR-MT) 136. The NCR device 130 includes an NCR forwarding section 138 that receives and amplifies a DL radio frequency (RF) signal received via the backhaul link 134 and forwards the DL RF signal with minimal delay via an access link 140 to the UE 104c. Similarly, the NCR forwarding section 138 receives and amplifies an UL RF signal received via the access link 140 and forwards the UL RF signal with minimal delay via the backhaul link to the network device 102a. The network device 102a is able to configure the NCR forwarding section 138 via configuration information sent via the side control link 132 to the NCR-MT 136. NCR device 130 has capabilities such as supported beams 211a through 211n for supporting NCR-Fwd access link 140 for UE 104c. NCR device 130 communicates capacity report 215, which includes beam indications 216, via backhaul beam(s) 217 on control link 132 to network device 102a.

Aspects of the present disclosure may apply more generally to communication links referred to with different labels. In one or more embodiments, the control link 132 may generally be a first link, the backhaul link 134 may generally be a second link, and the access link 140 may generally be a third link.

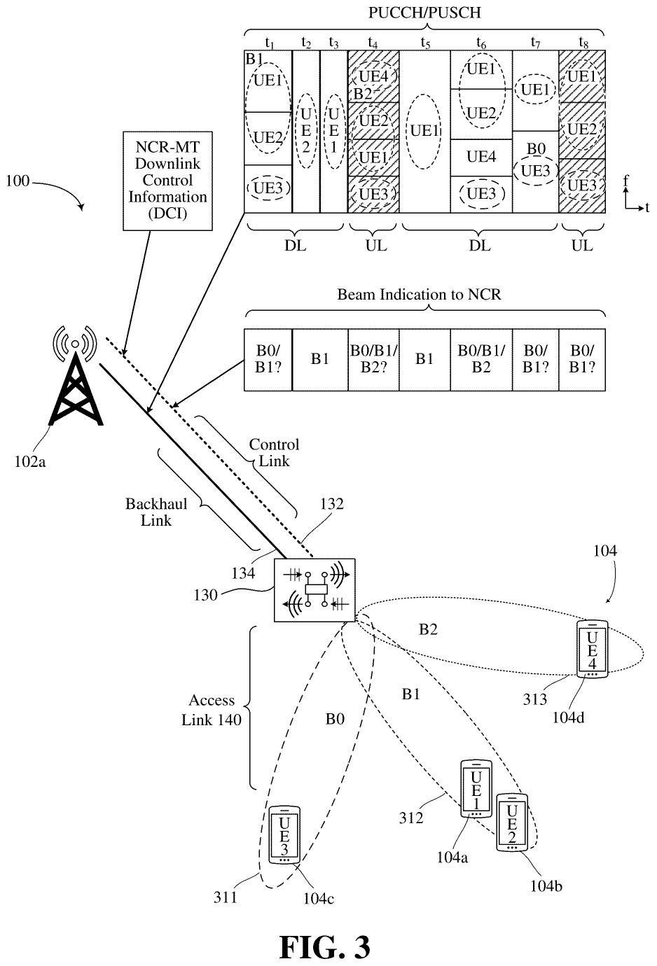

FIG. 3 is an example of the wireless communications system 100 including the network device 102a, an NCR device 130 and UEs 104 that are outside of a coverage area 110a (FIG. 1) for the network device 102a. NCR device 130 communicates with access link 140 using beams B0 311, B1 312, and B2 313. First user device UE1 104a and second user device UE2 104b are positioned in beam B1 312. Third user device UE3 104c is in beam B0311. Fourth user device UE4 104d. The network device 102a schedules UEs based on a beam indication of the access link that takes into account the frequency domain multiplexed UEs. In the legacy NR scheduling procedure, gNB scheduler can schedule multiple UEs in the same symbol/slot with different RB allocations. As per the scheduler implementation, it is important to schedule UEs that report same beam index in the frequency domain, i.e., according to an FDM scheme, and UEs with different beams in the time domain, i.e., according to an TDM scheme, as the beam switching is performed in the time domain per slot or per symbol for an RF chain and/or an antenna panel. By introducing the network-controlled repeater, it is noted that the beam transmission from gNB perspective towards the repeater in the backhaul link doesn't require frequency beam switching as the gNB and repeater both have fixed location and a single backhaul beam can be used for all UEs connected via the repeater. Therefore, for efficient UE scheduling, it is still possible from gNB perspective to use the same transmission beam and schedule multiple UEs in the frequency domain in the same slot/symbol, while the UEs are served by different access beams at the repeater access link. This enhances the scheduling efficiency, but at the same time requires consideration when indicating the beam indexes and the corresponding time domain resources to the repeater for the access link. UE1, UE2, UE3, and UE4 are connected to the gNB via different access beams and some of them are scheduled in frequency domain using FDM.

In Embodiment 1, the present disclosure provides access link beam indication for network-controlled repeater for broadcast transmission. According to embodiment 1, NCR-MT is configured with using common or a repeater dedicated RRC and/or a repeater dedicated DCI (rDCI), wherein the configuration message(s) carries information of beam indexes and the corresponding time domain resources to be used in the access link. The gNB, based on the reported repeater capability, during the attach procedure of NCR-MT or based on gNB request, of supported analog beams for the access link and their characteristics, performs mapping/association of the beams indicated to the UEs and the beams reported by the repeater for the access link. The reported capability from the repeater is sent in NCR-MT UL using PUCCH or PUSCH of the NCR-MT in the C link. Wherein the repeater capability may include the beam capability information that may contain the maximum number of the supported DL transmission and UL reception beams, the 3 dB beamwidth for each beam and association/grouping of narrow beams within the wide beams. The wide beams can be used for forwarding the broadcast channels or channels/signals during the initial access such as SSBs/PRACH/common DCI etc., while the narrow beams can be used for dedicated RS/data transmission to a UE(s) after or during beam refinement.

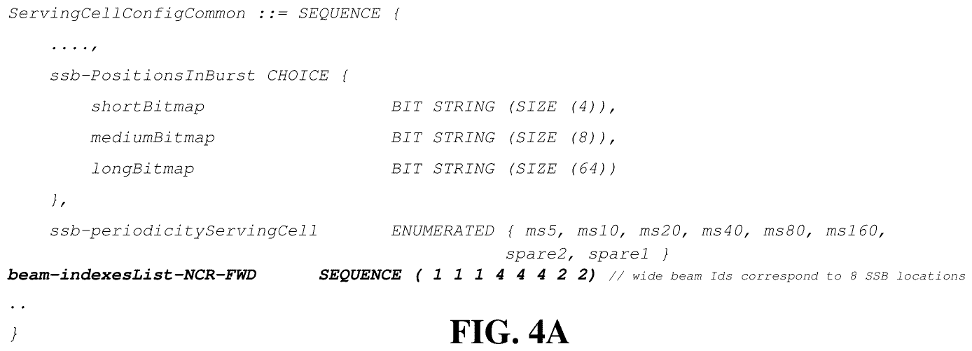

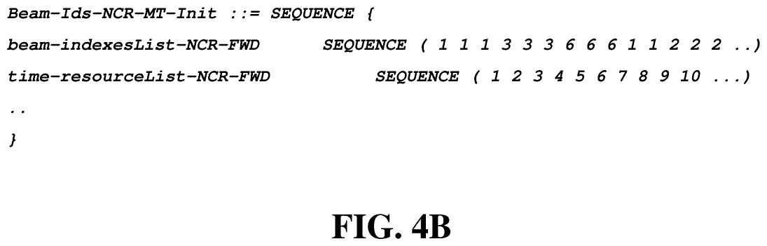

For broadcast/common transmission, the gNB based on the indicated repeater capability identifies the beams that need to be used for forwarding the broadcast channels (e.g., for initial access of the UEs), and semi-statically configures the repeater to use the reported wide beams during the locations of SSBs, ROs, common DCI, etc. In one implementation, FIG. 4A is an example code that can be signaled to NCR-MT using a common configuration, e.g., as part of ServingCellConfigCommon.

In another implementation the beam indexes can be sent to the repeater using repeater dedicated RRC message. The gNB sends to the repeater the beam indexes and the corresponding time slots for forwarding the broadcast channels/signals. In one implementation the repeater receives information about the beam index to be used for each time slot of the broadcasted channel. In another implementation the repeater is indicated with the mapping for a single SSB/RO burst, and the repeater applies the same configuration for the rest of SSB/PRACH transmission based on the configured periodicity in SIB, as long as there is no indication from the gNB to use different configuration. FIG. 4B is an example of dedicated RRC message to the repeater with beam IDs indication and the corresponding time resources.

In Embodiment 2, the present disclosure provides an access link beam indication for network-controlled repeater for unicast transmission/reception. According to embodiment 2, NCR-MT is configured using a repeater dedicated RRC and/or dynamically configured using a repeater dedicated DCI (rDCI), wherein the configuration message carries information of beam indexes and the corresponding time domain resources to be used in the access link. The gNB, based on the reported repeater capability, during the attach procedure of NCR-MT or based on gNB request, of supported analog beams for the access link and their characteristics, performs mapping/association of the beams indicated to the UEs and the beams reported by the repeater for the access link. The reported capability from the repeater is sent in NCR-MT UL using PUCCH or PUSCH of the NCR-MT in the C link. Wherein the repeater capability may include the beam capability information that may contain the maximum number of the supported DL transmission and UL reception beams, the 3 dB beamwidth for each beam and association/grouping of narrow beams within the wide beams. The wide beans can be used for forwarding the broadcast channels such as /Bs/PRACH/ common DCI etc., while the narrow beams can be used for dedicated RS/data transmission after or during beam refinement.

For the UE dedicated data/RS transmission, as multiple UEs maybe scheduled in the same time domain resource (time domain scheduling unit) which can be a slot or a symbol. The indication of the corresponding beam for the time slot needs to consider the different frequency domain scheduled UEs in that time slot and the fact that the repeater beamforming is time domain-based and cannot perform beamforming for different frequency bands within a slot.

With continued reference to FIG. 3, gNB schedules UEs served by the NCR device using different access beams. UE1, UE2, and UE3 are scheduled in DL in the same time slot with the same backhaul transmission beam, and UE 3 reports a best beam, which corresponds to the best NCR-Fwd access beam, which may be different than those of UE1and UE2. Also, UE1, UE2, UE3, and UE4 are scheduled in the UL with the same receive beam at the gNB but with different access beams at the repeater side. Based on recent developments in RAN1, the gNB indicates beam ID and the corresponding time resource for each beam ID at the access link for the repeater to apply while forwarding signals in the DL direction to the UE and signals in the UL direction to the gNB. Since the repeater operation in the forward link is time domain based and the repeater has no access to the frequency allocation details in a slot/symbol, gNB needs to decide which access beam to indicate to the repeater for a certain time domain scheduling unit. Therefore, the indication needs to consider the frequency domain scheduled UEs and the repeater capability of simultaneous beam transmission in the access link.

The gNB indicates two sets of beam IDs and corresponding time resources, one for DL and the other one for UL. In one implementation, if the scheduled UEs /e/ can be served with the same beam, the gNB associates/maps that beam with the corresponding beam index at the repeater access link and indicates to the repeater that beam along with the corresponding time domain scheduling unit (time domain resource in terms of symbol(s)/slot(s)). The indication of the time domain resource can be a slot index, a symbol index within a slot or using the starting symbol and length for the corresponding beam to be applied, e.g., Start and length indicator value (SLIV). In another implementation, if the UEs scheduled in a slot are/need to be served with different beams then the gNB associates the best access beam that can serve the UEs. The selection of the suitable beam index may depend on the measurement reports of UEs for different beams. The gNB selects the beam that has been commonly reported by multiple UEs with RSRPs that satisfy a threshold, e.g., a wide beam covering the narrow beams of the UEs that is reported with a satisfactory RSRP from multiple UEs. The selected beam may not be the optimal beam for all UEs. However, it can be used as a compromise to serve the different UEs scheduled in the same time domain scheduling unit.

In another implementation, if the UEs scheduled in a slot are/need to be served with different beams then the gNB associates the best repeater-access beam based on the priority of the UEs traffic and/or whether the transmission is a new data or re-transmission and giving the re-transmission the highest priority. For example, the beam index associated with the best CSI-RS beam reported by a UE with the most critical data or with re-transmission of a failed TB is prioritized and indicated to the repeater to be applied in that time slot.

In another implementation, if the UEs scheduled in a slot are/need to be served with different beams and upon receiving a capability information from the repeater that it can support multiple simultaneous analog beam transmissions, then the gNB indicates to the repeater multiple beam indexes for a time scheduling units, wherein the indicated beams are associated with the best reported CSI-RS beam for each scheduled UE in that time domain scheduling unit.

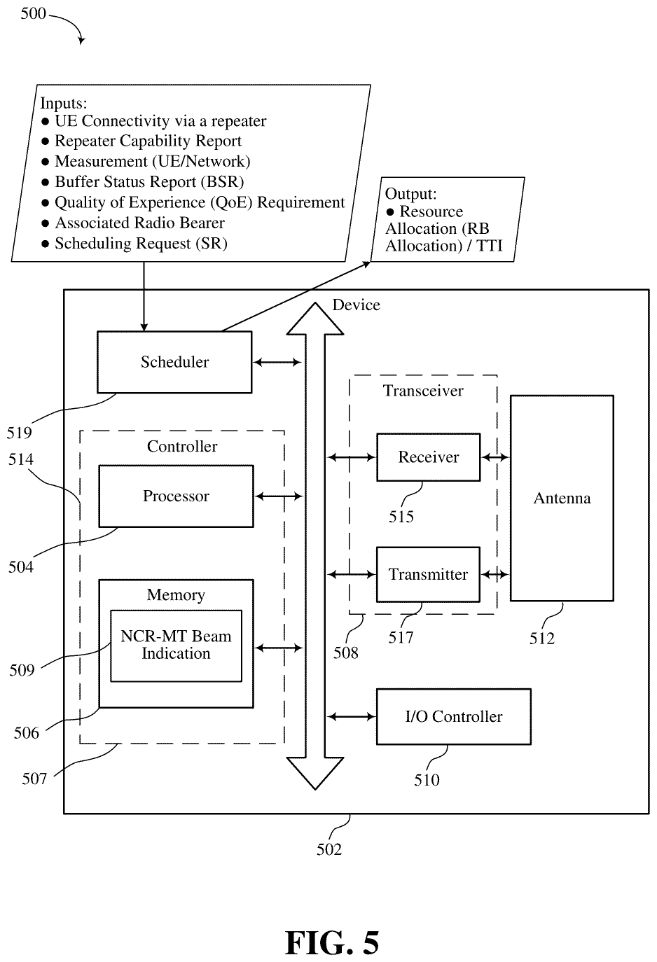

FIG. 5 illustrates an example of a block diagram 500 of a device 502 that supports beam indication for an NCR device, in accordance with aspects of the present disclosure. The device 502 may be an example of a network entity or network device 102 or a UE 104 (FIG. 1) as described herein. The device 502 may support wireless communication with one or more network entities or network devices 102, UEs 104, or any combination thereof. The device 502 may include components for bi-directional communications including components for transmitting and receiving communications, such as a processor 504, a memory 506, a transceiver 508, and an I/O controller 510. These components may be in electronic communication or otherwise coupled (e.g., operatively, communicatively, functionally, electronically, electrically) via one or more interfaces (e.g., buses).

The processor 504, the memory 506, the transceiver 508, or various combinations thereof or various components thereof may be examples of means for performing various aspects of the present disclosure as described herein. For example, the processor 504, the memory 506, the transceiver 508, or various combinations or components thereof may support a method for performing one or more of the operations described herein.

In some implementations, the processor 504, the memory 506, the transceiver 508, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. A controller 507 includes the processor 504 that configures the device 502 to perform the functionality of the present disclosure. The controller 507 is communicatively coupled to the memory 506 to execute program code. Controller 507 may include dedicated memory solely accessible by the processor 504 that is a portion of memory 506. In some implementations, the processor 504 and the memory 506 coupled with the processor 504 may be configured to perform one or more of the functions as a controller 507 described herein (e.g., executing, by the processor 504, instructions stored in the memory 506). In an example, the processor 504 of a device controller 514 executes an NCR beam indication application 509 to function as an NCR-MT in determining a beam indication for configuring a transceiver 508 of the device 502 to perform NCR forwarding.

The processor 504 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 504 may be configured to operate a memory array using a memory controller. In some other implementations, a memory controller may be integrated into the processor 504. The processor 504 may be configured to execute computer-readable instructions stored in a memory (e.g., the memory 506) to cause the device 502 to perform various functions of the present disclosure.

The memory 506 may include random access memory (RAM) and read-only memory (ROM). The memory 506 may store computer-readable, computer-executable code including instructions that, when executed by the processor 504 cause the device 502 to perform various functions described herein. The code may be stored in a non-transitory computer-readable medium such as system memory or another type of memory. In some implementations, the code may not be directly executable by the processor 504 but may cause a computer (e.g., when compiled and executed) to perform functions described herein. In some implementations, the memory 506 may include, among other things, a basic I/O system (BIOS) which may control basic hardware or software operation such as the interaction with peripheral components or devices.

The I/O controller 510 may manage input and output signals for the device 502. The I/O controller 510 may also manage peripherals not integrated into the device M02. In some implementations, the I/O controller 510 may represent a physical connection or port to an external peripheral. In some implementations, the I/O controller 510 may utilize an operating system such as iOS®, ANDROID®, MS-DOS®, MS-WINDOWS®, OS/2®, UNIX®, LINUX®, or another known operating system. In some implementations, the I/O controller 510 may be implemented as part of a processor, such as the processor 504. In some implementations, a user may interact with the device 502 via the I/O controller 510 or via hardware components controlled by the I/O controller 510.

In some implementations, the device 502 may include a single antenna 512. However, in some other implementations, the device 502 may have more than one antenna 512 (i.e., multiple antennas), including multiple antenna panels or antenna arrays, which may be capable of concurrently transmitting or receiving multiple wireless transmissions. The transceiver 508 may communicate bi-directionally using one or more receivers 515 and one or more transmitters 517, via the one or more antennas 512, wired, or wireless links as described herein. For example, the transceiver 508 may represent a wireless transceiver and may communicate bi-directionally with another wireless transceiver. The transceiver 508 may also include a modem to modulate the packets, to provide the modulated packets to one or more antennas 512 for transmission, and to demodulate packets received from the one or more antennas 512.

According to aspects of the present disclosure, the device 502 may be an NCR device 130 (FIGS. 1-6) for repeating wireless communication. The device 502 has the at least one transceiver 508 that includes at least one receiver 515 and at least one transmitter 517 that enable the device 502 to communicate with a network entity or network device 102a and to a user device such as UE 104a (FIG. 1). In particular, the at least one transceiver 508 enables the device 502 to communicate: (i) with at least one network device 102a (FIG. 1) of a wireless communications system 100 (FIG. 1) via (a) a control link 132 (FIGS. 1-5) or (b) a backhaul link 134 (FIGS. 1-5) ; and (ii) with a user device (UE 104a (FIG. 1)) via an access link 140 (FIGS. 1-5) . A controller 514 of the device 502 is communicatively coupled to the at least one transceiver 508.

According to aspects of the present disclosure, the device 502 may be network device 102 (FIGS. 1-3) for configuring NCR device 130 for repeating wireless communication. The device 502 may include a scheduler 519 that is communicatively coupled to the controller 514. In some implementations, the scheduler 519 may be configured to perform various operations (e.g., receiving, monitoring, transmitting) using or otherwise in cooperation with the receiver 515, the transmitter 517, or both. For example, the scheduler 519 may receive information from the receiver 515, send information to the transmitter 517, or be integrated in combination with the receiver 515, the transmitter 517, or both to receive information, transmit information, or perform various other operations as described herein. Although the scheduler 519 is illustrated as a separate component, in some implementations, one or more functions described with reference to the scheduler 519 may be supported by or performed by a processing subsystem such as controller 514, the memory 506, or any combination thereof. For example, the memory 506 may store code, which may include instructions executable by the controller 514 to cause/configure the device 502 to perform various aspects of the present disclosure as described herein, or the controller 514 and the memory 506 may be otherwise configured to perform or support such operations.

According to aspects of the present disclosure, the scheduler 519 uses an NCR capability report and information regarding UE connectivity via a repeater when considering scheduling for UEs 104 (FIG. 1). According to the above embodiments, the reported capability of beam information along with the reported measurements of the served UEs of access beams, the scheduler considers this information for grouping the UEs for efficient scheduling.

Upon determining that the UEs 104 (FIG. 1) are (or can be) served by a repeater, the scheduler 519 considers this information to group the UEs 104 (FIG. 1) based on their connectivity or potential connectivity via a repeater. Upon receiving measurement reports of access beams of the UEs 104 (FIG. 1) connected via a repeater, the scheduler 519 groups the UEs 104 (FIG. 1) that report a similar beam and gives the UEs 104 (FIG. 1) priority for FDM scheduling. UEs 104 (FIG. 1) with different best access beam reporting are scheduled in TDM manner. If the repeater can support simultaneous beam transmission, the scheduler 519 may schedule UEs 104 (FIG. 1) with different reported best beams in FDM and the device 502 indicates these beams to the repeater to serve these UEs. 104 (FIG. 1).

According to one or more aspects of the present disclosure, a device 502 such as a network device 102 (FIG. 1) is provided for wireless communication. In one or more embodiments, the device 502 includes at least one transceiver 508 that enables the device 502 to communicate: (i) with a repeater device (e.g., NCR device 130 (FIG. 1) via a first link such as control link 132 (FIG. 1); and (ii) indirectly with a user device (e.g., UEs. 102 (FIG. 1)) via a second link such backhaul link 134 (FIG. 1) as to the repeater device that repeats communication via a third link such as access link 140 (FIG. 1) with the user device. A controller 507 is communicatively coupled to the at least one transceiver 508. The controller 507 receives, via the at least one transceiver 508 from the repeater device, a beam designation of two or more beams of the repeater device capable of communicating with two or more user devices via the third link. The device 502 determines that the beam designation identifies two or more user devices in a first beam of the two or more beams. In response, the device 502 generates a first configuration of a beam identifier for the first beam and corresponding time domain resources for the two or more user devices using frequency division multiplexing. The device 502 transmits, via the at least one transceiver to the repeater device, one or more control messages including the first configuration. The first configuration prompts the repeater device to apply the configuration for transmission of a downlink and reception of an uplink on the third link between the repeater device and the two or more user devices using the first beam.

In one or more embodiments, the controller 507 determines that the beam designation identifies two or more user devices in different beams of the two or more beams. In response, the controller 507 generates a second configuration of two or more beam identifiers of the different beams and corresponding time domain resources for the two or more user devices using time division multiplexing. The controller 507 transmits, via the at least one transceiver to the repeater device, one or more control messages including the second configuration. The second configuration prompts the repeater device to apply the second configuration for transmission of a downlink and reception of an uplink on the third link between the repeater device and the two or more user devices to non-concurrently use the first beam and the second beam.

In one or more particular embodiments, in response to determining a beam capability of the repeater device includes simultaneous beam transmission, the controller 507 transmits the second configuration including an indication of two or more beam identifiers and simultaneous time resources for a slot/symbol to be applied at the repeater device for simultaneous beam transmission.

In one or more embodiments, the controller 507 determines: (i) a beam capability of the repeater device comprises one or more wide beams; and (ii) content scheduled for being repeated by the repeater device comprises broadcast content. In response, the controller 507 transmits the first configuration comprising an indication of one or more beam identifiers and time resources that correspond to the one or more wide beams. In one or more embodiments, the controller 507 transmits the first configuration via a repeater dedicated radio resource control (RRC) message.

In one or more embodiments, the controller 507 determines: (i) a beam capability of the repeater device comprises one or more narrow beams; and (ii) content scheduled for being repeated by the repeater device is user equipment (UE) dedicated content. In response, the controller 507 transmits the first configuration comprising an indication of one or more beam identifiers and time resources that correspond to the one or more narrow beams.

In one or more embodiments, the controller 507 generates the first configuration in a repeater dedicated Downlink Control Information (DCI) format. In one or more embodiments, the controller 507 transmits the first configuration that is scheduled in frequency domain in a slot/symbol. The one or more beam identifiers correspond to a beam of a user device of the two or more user devices having high priority data. In one or more embodiments, the controller 507 prioritizes scheduling in the first configuration according to Quality of Service (QoS) of the two or more user devices and assigns a higher priority to re-transmissions versus new data transmissions.

In one or more embodiments, the controller 507 receives, via the at least one transceiver from the repeater device: (i) a repeater capability report comprising the beam designation of two or more beams of the repeater device for the third link; (ii) identification of the two or more UEs connected to the repeater device via the third link; and (iii) identification of whether each of the two or more user devices may be served by a same beam of the two more beams or whether different beams are required. The controller 507 generates the first configuration based on the repeater capability report, the identification of the two or more UE, and the identification of same or different beams.

According to one or more aspects of the present disclosure, a device 502 such as an NCR device 130 (FIG. 1) is provided for wireless communication. In one or more embodiments, the device 502 includes at least one transceiver 508 that enables the device 502 to communicate: (i) with at least one network device 102 (FIG. 1) of a network via (a) a first link (e.g., control link 132 (FIG. 1) or (b) a second link (e.g., backhaul link 134 (FIG. 2)); and (ii) with a user device (e.g., UE 104 (FIG. 1)) via a third link (e.g., access link (FIG. 1)). A controller 507 of the device 502 is communicatively coupled to the at least one transceiver 508. The controller 507 transmits, via the at least one transceiver 508 to the at least one network device, a beam designation of two or more beams of the device 502 capable of communicating with two or more user devices via the third link. The at least one network device responds to determining that the beam designation identifies two or more user devices in a first beam of the two or more beams by generating a first configuration of a beam identifier for the first beam and corresponding time domain resources for the two or more user devices using frequency division multiplexing. The controller 507 receives, via the at least one transceiver 508 from the at least one network device, one or more control messages including the first configuration. The controller 507 applies the configuration to the at least one transceiver for transmission of a downlink and reception of an uplink on the third link between the repeater device and the two or more user devices using the first beam.

In one or more embodiments, the controller 507 receives, via the at least one transceiver from the at least one network device, one or more control messages including a second configuration. The at least one network device determines that the beam designation identifies two or more user devices in different beams of the two or more beams. In response, the at least one network device generates the second configuration of two or more beam identifiers of the different beams and corresponding time domain resources for the two or more user devices using time division multiplexing. The controller 507 applies the second configuration for transmission of a downlink and reception of an uplink on the third link between the repeater device and the two or more user devices to non-concurrently use the first beam and the second beam.

In one or more particular embodiments, the controller 507 transmits a beam capability report to the at least one network device indicating a beam capability of simultaneous beam transmission prompting the at least one network device to generate the second configuration comprising simultaneous beam transmission. The controller 507 applies an indication of the second configuration of two or more beam identifiers and simultaneous time resources for a slot/symbol at the repeater device for simultaneous beam transmission.

In one or more embodiments, the controller 507 transmits, to the at least one network device, a beam capability report indicating a beam capability one or more wide beams. The controller 507 receives the first configuration comprising an indication of one or more beam identifiers and time resources that correspond to the one or more wide beams. The controller 507 applies the first configuration to the at least one transceiver to repeat broadcast content.

In one or more embodiments, the controller 507 receives the first configuration via a repeater dedicated radio resource control (RRC) message. In one or more embodiments, the controller 507 transmits, to the at least one network device, a beam capability report indicating a beam capability one or more wide beams. The controller 507 receives the first configuration comprising an indication of one or more beam identifiers and time resources that correspond to the one or more narrow beams. The controller 507 applies the first configuration to the at least one transceiver to repeat user equipment (UE) dedicated content.

In one or more embodiments, the controller 507 receives, via the at least one transceiver 508, the first configuration in a repeater dedicated Downlink Control Information (DCI) format. In one or more embodiments, the controller 507 receives the first configuration that is scheduled in frequency in a slot/symbol, wherein the one or more beam identifiers correspond to a beam of a user device of the two or more user devices having high priority data. In one or more embodiments, the controller 507 receives prioritized scheduling in the first configuration according to Quality of Service (QoS) of the two or more user devices and assigns a higher priority to re-transmissions versus new data transmissions.

In one or more embodiments, the controller 507 transmits, via the at least one transceiver 508 from the repeater device: (i) a repeater capability report comprising the beam designation of two or more beams of the repeater device for the third link; (ii) identification of the two or more UEs connected to the repeater device via the third link; and (iii) identification of whether each of the two or more user devices may be served by a same beam of the two more beams or whether different beams are required. The transmission prompts the at least one network device to generate the first configuration based on the repeater capability report, the identification of the two or more UE, and the identification of same or different beams.

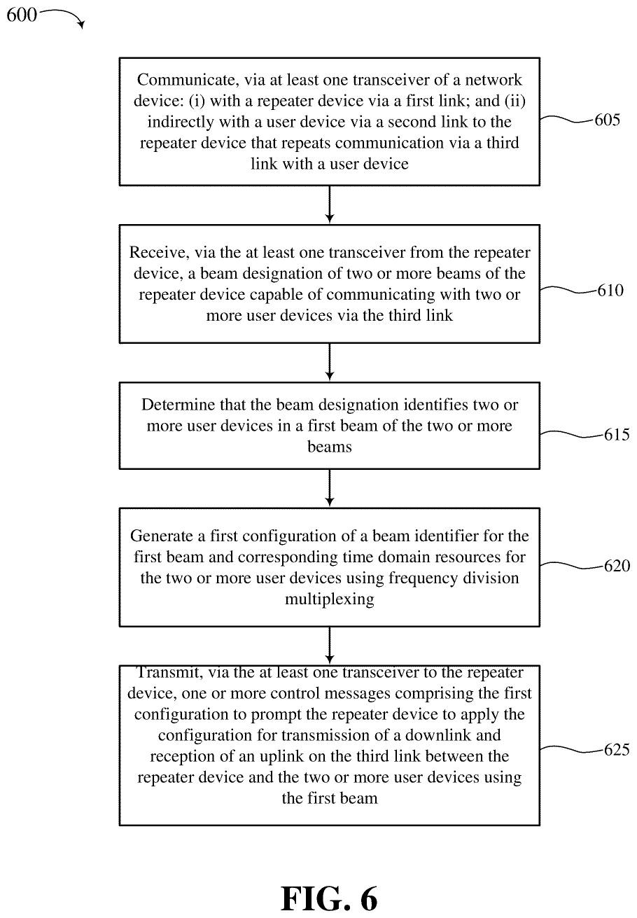

FIG. 6 illustrates a flowchart of a method 600 for wireless communication at a network device that configures a repeater device for extended coverage, in accordance with aspects of the present disclosure. The operations of the method 600 may be implemented by a device or its components as described herein. For example, the operations of the method 600 may be performed by a network device such as network device 102 (FIGS. 1-3) or device 502 (FIG. 5). In some implementations, the network device may execute a set of instructions to control the function elements of the network device to perform the described functions. Additionally, or alternatively, the user device may perform aspects of the described functions using special-purpose hardware.

At 605, the method 600 may include communicating, via at least one transceiver of a network device: (i) with a repeater device via a first link; and (ii) indirectly with a user device via a second link to the repeater device that repeats communication via a third link with a user device. The operations of 605 may be performed in accordance with examples as described herein. In some implementations, aspects of the operations of 605 may be performed by a device as described with reference to FIGS. 1-3 and 5 .

At 610, the method 600 may include receiving, via the at least one transceiver from the repeater device, a beam designation of two or more beams of the repeater device capable of communicating with two or more user devices via the third link. The operations of 610 may be performed in accordance with examples as described herein. In some implementations, aspects of the operations of 610 may be performed by a device as described with reference to FIGS. 1-3 and 5 .

At 615, the method 600 may include determining that the beam designation identifies two or more user devices in a first beam of the two or more beams. The operations of 615 may be performed in accordance with examples as described herein. In some implementations, aspects of the operations of 615 may be performed by a device as described with reference to FIGS. 1-3 and 5 .

At 620, the method 600 may include generating a first configuration of a beam identifier for the first beam and corresponding time domain resources for the two or more user devices using frequency division multiplexing. The operations of 620 may be performed in accordance with examples as described herein. In some implementations, aspects of the operations of 620 may be performed by a device as described with reference to FIGS. 1-3 and 5.

At 625, the method 600 may include transmitting, via the at least one transceiver to the repeater device, one or more control messages comprising the first configuration to prompt the repeater device to apply the configuration for transmission of a downlink and reception of an uplink on the third link between the repeater device and the two or more user devices using the first beam. The operations of 625 may be performed in accordance with examples as described herein. In some implementations, aspects of the operations of 625 may be performed by a device as described with reference to FIGS. 1-3 and 5 .

According to one or more aspects of the present disclosure, in response to determining that the beam designation identifies two or more user devices in different beams of the two or more beams, the method 600 may further include generating a second configuration of two or more beam identifiers of the different beams and corresponding time domain resources for the two or more user devices using time division multiplexing. The method 600 may include transmitting, via the at least one transceiver to the repeater device, one or more control messages including the second configuration. The second configuration is to prompt the repeater device to apply the second configuration for transmission of a downlink and reception of an uplink on the third link between the repeater device and the two or more user devices to non-concurrently use the first beam and the second beam.

In one or more embodiments, in response to determining a beam capability of the repeater device comprises simultaneous beam transmission, the method 600 may further include transmitting the second configuration including an indication of two or more beam identifiers and simultaneous time resources for a slot/symbol to be applied at the repeater device for simultaneous beam transmission.

In one or more embodiments, the method 600 may further include determining: (i) a beam capability of the repeater device comprises one or more wide beams; and (ii) content scheduled for being repeated by the repeater device comprises broadcast content. In response, the method 600 may further include transmitting the first configuration including an indication of one or more beam identifiers and time resources that correspond to the one or more wide beams.

In one or more embodiments, the method 600 may further include transmitting the first configuration via a repeater dedicated radio resource control (RRC) message. In one or more embodiments, the method 600 may further include determining: (i) a beam capability of the repeater device comprises one or more narrow beams; and (ii) content scheduled for being repeated by the repeater device comprises user equipment (UE) dedicated content. In response, the method 600 may further include transmitting the first configuration comprising an indication of one or more beam identifiers and time resources that correspond to the one or more narrow beams.

In one or more embodiments, the method 600 may further include generating the first configuration in a repeater dedicated Downlink Control Information (DCI) format. In one or more embodiments, the method 600 may further include transmitting the first configuration that is scheduled in frequency domain in a slot/symbol. The one or more beam identifiers correspond to a beam of a user device of the two or more user devices having high priority data. In one or more embodiments, the method 600 may further include prioritizing scheduling in the first configuration according to Quality of Service (QoS) of the two or more user devices and assigns a higher priority to re-transmissions versus new data transmissions.

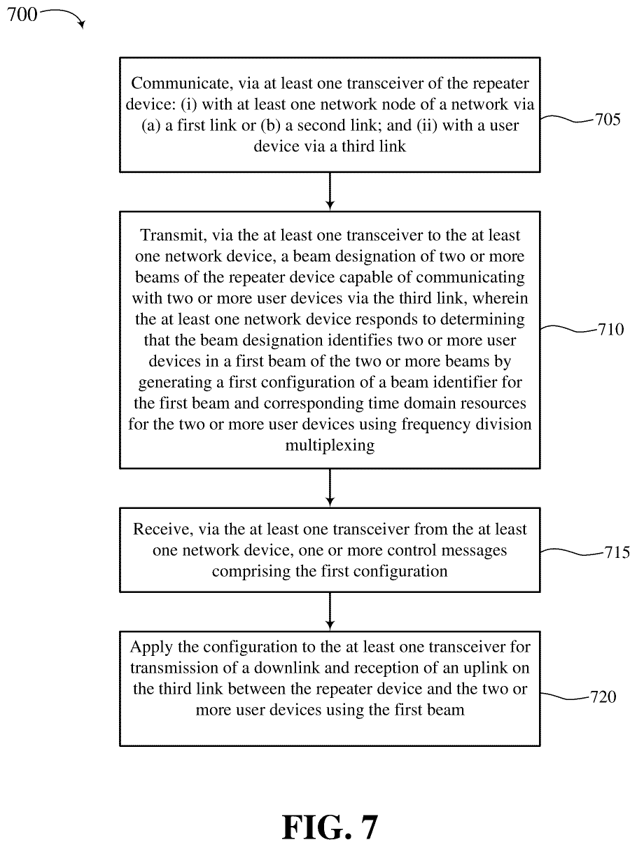

In one or more embodiments, the method 600 may further include receiving, via the at least one transceiver from the repeater device: (i) a repeater capability report comprising the beam designation of two or more beams of the repeater device for the third link; (ii) identification of the two or more UEs connected to the repeater device via the third link; and (iii) identification of whether each of the two or more user devices may be served by a same beam of the two more beams or whether different beams are required. The method 600 may further include generating the first configuration based on the repeater capability report, the identification of the two or more UE, and the identification of same or different FIG. 7 illustrates a flowchart of a method 700 for wireless communication at a repeater device, in accordance with aspects of the present disclosure. The operations of the method 700 may be implemented by a device or its components as described herein. For example, the operations of the method 700 may be performed by a repeater device such as NCR device 130 (FIGS. 1-3) or device 502 (FIG. 5). In some implementations, the user device may execute a set of instructions to control the function elements of the network device to perform the described functions. Additionally, or alternatively, the user device may perform aspects of the described functions using special-purpose hardware.

At 705, the method 700 may include communicating, via at least one transceiver of the repeater device: (i) with at least one network node of a network via (a) a first link or (b) a second link; and (ii) with a user device via a third link. The operations of 705 may be performed in accordance with examples as described herein. In some implementations, aspects of the operations of 705 may be performed by a device as described with reference to FIGS. 1-3 and 5 .

At 710, the method 700 may include transmitting, via the at least one transceiver to the at least one network device, a beam designation of two or more beams of the repeater device capable of communicating with two or more user devices via the third link. The at least one network device responds to determining that the beam designation identifies two or more user devices in a first beam of the two or more beams by generating a first configuration of a beam identifier for the first beam and corresponding time domain resources for the two or more user devices using frequency division multiplexing. The operations of 710 may be performed in accordance with examples as described herein. In some implementations, aspects of the operations of 710 may be performed by a device as described with reference to FIGS. 1-3 and 5 .

At 715, the method 700 may include receiving, via the at least one transceiver from the at least one network device, one or more control messages comprising the first configuration. The operations of 715 may be performed in accordance with examples as described herein. In some implementations, aspects of the operations of 715 may be performed by a device as described with reference to FIGS. 1-3 and 5.

At 720, the method 700 may include applying the configuration to the at least one transceiver for transmission of a downlink and reception of an uplink on the third link between the repeater device and the two or more user devices using the first beam. The operations of 720 may be performed in accordance with examples as described herein. In some implementations, aspects of the operations of 720 may be performed by a device as described with reference to FIGS. 1-3 and 5 .

According to one or more aspects of the present disclosure, the method 700 may further include communicating, via at least one transceiver of a repeater device: (i) with at least one network node of a network via (a) a first link or (b) a second link; and (ii) with a user device via a third link. The method 700 may further include transmitting, via the at least one transceiver to the at least one network device, a beam designation of two or more beams of the repeater device capable of communicating with two or more user devices via the third link. The at least one network device determines that the beam designation identifies two or more user devices in a first beam of the two or more beams. In response, the at least one network device generates a first configuration of a beam identifier for the first beam and corresponding time domain resources for the two or more user devices using frequency division multiplexing. The method 700 may include receiving, via the at least one transceiver from the at least one network device, one or more control messages including the first configuration. The method 700 may include applying the configuration to the at least one transceiver for transmission of a downlink and reception of an uplink on the third link between the repeater device and the two or more user devices using the first beam.

In one or more embodiments, the method 700 may include receiving, via the at least one transceiver from the network device, one or more control messages including a second configuration. The at least one network determines that the beam designation identifies two or more user devices in different beams of the two or more beams. In response, the at least one network generates the second configuration of two or more beam identifiers of the different beams and corresponding time domain resources for the two or more user devices using time division multiplexing. The method 700 may include applying the second configuration for transmission of a downlink and reception of an uplink on the third link between the repeater device and the two or more user devices to non-concurrently use the first beam and the second beam.

In one or more particular embodiments, the method 700 may include transmitting a beam capability report to the at least one network device indicating a beam capability of simultaneous beam transmission. The beam capability report prompts the at least one network device to generate the second configuration comprising simultaneous beam transmission. The method 700 includes applying an indication of the second configuration of two or more beam identifiers and simultaneous time resources for a slot/symbol at the repeater device for simultaneous beam transmission.

In one or more embodiments, the method 700 may include transmitting, to the at least one network device, a beam capability report indicating a beam capability one or more wide beams. The method 700 may include receiving the first configuration including an indication of one or more beam identifiers and time resources that correspond to the one or more wide beams. The method 700 may include applying the first configuration to the at least one transceiver to repeat broadcast content. In one or more embodiments, the method 700 may include receiving the first configuration via a repeater dedicated radio resource control (RRC) message.

In one or more embodiments, the method 700 may include transmitting, to the at least one network device, a beam capability report indicating a beam capability one or more wide beams. The method 700 may include receiving the first configuration comprising an indication of one or more beam identifiers and time resources that correspond to the one or more narrow beams. The method 700 may include applying the first configuration to the at least one transceiver to repeat user equipment (UE) dedicated content.

In one or more embodiments, the method 700 may include receiving, via the at least one transceiver, the first configuration in a repeater dedicated Downlink Control Information (DCI) format. In one or more embodiments, the method 700 may include receiving the first configuration that is scheduled in frequency in a slot/symbol, wherein the one or more beam identifiers correspond to a beam of a user device of the two or more user devices having high priority data. In one or more embodiments, the method 700 may include receiving prioritized scheduling in the first configuration according to Quality of Service (QoS) of the two or more user devices and assigns a higher priority to re-transmissions versus new data transmissions.

In one or more embodiments, the method 700 may include transmitting, via the at least one transceiver from the repeater device: (i) a repeater capability report comprising the beam designation of two or more beams of the repeater device for the third link; (ii) identification of the two or more UEs connected to the repeater device via the third link; and (iii) identification of whether each of the two or more user devices may be served by a same beam of the two more beams or whether different beams are required. The transmission prompts the at least one network device to generate the first configuration based on the repeater capability report, the identification of the two or more UE, and the identification of same or different beams.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A base station for wireless communication, the base station comprising:
at least one memory; and
at least one processor communicatively coupled to the at least one memory and which is configured to cause the base station to:
receive, from a repeater device via a first link, a beam designation of two or more beams of the repeater device capable of communicating with two or more users equipments (UEs) via a third link, the base station communicatively coupled to each or more UEs via a respective second link, wherein the first link is a control link, second link is a backhaul link, and the third link is an access link; and
in response to determining that the beam designation identifies two or more UEs in a first beam of the two or more beams:
generate a first configuration of a beam identifier for the first beam and corresponding time domain resources for the two or more UEs using frequency division multiplexing; and
transmit, to the repeater device, one or more control messages comprising the first configuration to prompt the repeater device to apply the configuration for transmission of a downlink and reception of an uplink on the third link between the repeater device and the two or more user devices using the first beam.

2. The base station of claim 1, wherein the at least one processor is further configured to cause the base station to
in response to determining that the beam designation identifies two or more UEs in different beams of the two or more beams:
generate a second configuration of two or more beam identifiers of the different beams and corresponding time domain resources for the two or more UEs using time division multiplexing; and
transmit, via the at least one transceiver to the repeater device, one or more control messages comprising the second configuration to prompt the repeater device to apply the second configuration for transmission of a downlink and reception of an uplink on the third link between the repeater device and the two or more UEs to non-concurrently use the first beam and the second beam.

3. The base station of claim 1, wherein the at least one processor is further configured to cause the base station to:
in response to determining a beam capability of the repeater device comprises simultaneous beam transmission:
transmit a second configuration comprising an indication of two or more beam identifiers and simultaneous time resources for a slot/symbol to be applied at the repeater device for simultaneous beam transmission.

4. The base station of claim 1, wherein the at least one processor is further configured to cause the base station to:
in response to determining: (i) a beam capability of the repeater device comprises one or more wide beams; and (ii) content scheduled for being repeated by the repeater device comprises broadcast content:
transmit the first configuration comprising an indication of one or more beam identifiers and time resources that correspond to the one or more wide beams.

5. The base station of claim 1, wherein the at least one processor is further configured to cause the base station to transmit the first configuration via a repeater dedicated radio resource control (RRC) message.

6. The base station of claim 1, wherein the at least one processor is further configured to cause the base station to:
in response to determining: (i) a beam capability of the repeater device comprises one or more narrow beams; and (ii) content scheduled for being repeated by the repeater device comprises user equipment (UE) dedicated content:
transmit the first configuration comprising an indication of one or more beam identifiers and time resources that correspond to the one or more narrow beams.

7. The base station of claim 1, wherein the at least one processor is further configured to cause the base station to generate the first configuration in a repeater dedicated Downlink Control Information (DCI) format.

8. The base station of claim 1, wherein the at least one processor is further configured to cause the base station to transmit the first configuration that is scheduled in frequency domain in a slot/symbol, wherein the one or more beam identifiers correspond to a beam of a UE of the two or more UEs having high priority data.

9. (canceled)

10. The base station of claim 1, wherein the at least one processor is further configured to cause the base station to:
receive, from the repeater device:
a repeater capability report comprising the beam designation of two or more beams of the repeater device for the third link;
identification of the two or more UEs connected to the repeater device via the third link; and
identification of whether each of the two or more UEs may be served by a same beam of the two more beams or whether different beams are required; and
generate the first configuration based on the repeater capability report, the identification of the two or more UEs, and the identification of same or different beams.

11. A method for wireless communication at a base station, the method comprising:
receiving, from a repeater device, a beam designation of two or more beams of the repeater device capable of communicating with two or more UEs via a third link, the base station communicatively linked to the repeater device via a first link, to the two or more UEs via a respective second link, and to the repeater device via the third link, wherein the first link is a control link, the second link is a backhaul link, and the third link is an access link; and
in response to determining that the beam designation identifies two or more UEs in a first beam of the two or more beams:
generating a first configuration of a beam identifier for the first beam and corresponding time domain resources for the two or more UEs using frequency division multiplexing; and
transmitting, to the repeater device, one or more control messages comprising the first configuration to prompt the repeater device to apply the configuration for transmission of a downlink and reception of an uplink on the third link between the repeater device and the two or more UEs using the first beam.

12. The method of claim 11, further comprising:
in response to determining that the beam designation identifies two or more UEs in different beams of the two or more beams:
generating a second configuration of two or more beam identifiers of the different beams and corresponding time domain resources for the two or more UEs using time division multiplexing; and
transmitting, to the repeater device, one or more control messages comprising the second configuration to prompt the repeater device to apply the second configuration for transmission of a downlink and reception of an uplink on the third link between the repeater device and the two or more UEs to non-concurrently use the first beam and the second beam.

13. The method of claim 11, further comprising:
in response to determining a beam capability of the repeater device comprises simultaneous beam transmission, transmitting a second configuration comprising an indication of two or more beam identifiers and simultaneous time resources for a slot/symbol to be applied at the repeater device for simultaneous beam transmission.

14. The method of claim 11, further comprising:
in response to determining (i) a beam capability of the repeater device comprises one or more wide beams and (ii) content scheduled for being repeated by the repeater device comprises broadcast content, transmitting the first configuration comprising an indication of one or more beam identifiers and time resources that correspond to the one or more wide beams; and
in response to determining (i) a beam capability of the repeater device comprises one or more narrow beams and (ii) content scheduled for being repeated by the repeater device comprises user equipment (UE) dedicated content, transmitting the first configuration comprising an indication of one or more beam identifiers and time resources that correspond to the one or more narrow beams.

15. (canceled)

16. The method of claim 11, further comprising:
receiving, from the repeater device:
a repeater capability report comprising the beam designation of two or more beams of the repeater device for the third link;
identification of the two or more UE connected to the repeater device via the third link; and
identification of whether each of the two or more UEs may be served by a same beam of the two more beams or whether different beams are required; and
generating the first configuration based on the repeater capability report, the identification of the two or more UEs, and the identification of same or different beams.

17. A repeater device for wireless communication, the repeater device comprising:
at least one memory; and
at least one processor communicatively coupled to the at least one memory and which is configured to cause the repeater device to:
transmit, to at least one base station, a beam designation of two or more beams of the repeater device capable of communicating with two or more UEs via an access link, wherein the at least one base station responds to determining that the beam designation identifies two or more UEs in a first beam of the two or more beams by generating a first configuration of a beam identifier for the first beam and corresponding time domain resources for the two or more UEs using frequency division multiplexing;
receive, from the at least one base station, one or more control messages comprising the first configuration; and
apply the configuration to the at least one transceiver for transmission of a downlink and reception of an uplink on the access link between the repeater device and the two or more UEs using the first beam.

18. The repeater device of claim 17, wherein the at least one processor is configured to cause the repeater device to:
receive, from the base station, one or more control messages comprising a second configuration, wherein the at least one base station, in response to determining that the beam designation identifies two or more UEs in different beams of the two or more beams, generates the second configuration of two or more beam identifiers of the different beams and corresponding time domain resources for the two or more UEs using time division multiplexing; and
apply the second configuration for transmission of a downlink and reception of an uplink on the access link between the repeater device and the two or more UEs to non-concurrently use the first beam and the second beam.

19. The repeater device of claim 18, wherein the at least one processor is configured to cause the repeater device to:
transmit a beam capability report to the at least one base station indicating a beam capability of simultaneous beam transmission prompting the at least one base station to generate the second configuration comprising simultaneous beam transmission; and
apply an indication of the second configuration of two or more beam identifiers and simultaneous time resources for a slot/symbol at the repeater device for simultaneous beam transmission.

20. The repeater device of claim 17, wherein the at least one processor is configured to cause the repeater device to:
transmit, from the repeater device:
a repeater capability report comprising the beam designation of two or more beams of the repeater device for the third link;
identification of the two or more UEs connected to the repeater device via the third link; and
identification of whether each of the two or more UEs may be served by a same beam of the two more beams or whether different beams are required, prompting the at least one base station to generate the first configuration based on the repeater capability report, the identification of the two or more UEs, and the identification of same or different beams.

21. The method of claim 11, wherein transmitting the one or more control messages comprises transmitting the first configuration via a repeater dedicated radio resource control (RRC) message.

22. The method of claim 11, further comprising generating the first configuration in a repeater dedicated Downlink Control Information (DCI) format.
